(19) United States
(12) Patent Application Publication
(10) Pub. No.: US 2014/0347004 A1
(43) Pub. Date: Nov. 27, 2014

(54) CHARGING CONTROL CIRCUIT AND ELECTRONIC DEVICE WITH THE SAME

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: ZHEN-JI XU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/253,998

(22) Filed: Apr. 16, 2014

(30) Foreign Application Priority Data
May 24, 2013 (CN) 201310194763X

(51) Int. Cl. H02J 7/00

(52) U.S. Cl. CPC H02J 7/0052; H02J 7/007
USPC 320/107

(57) ABSTRACT

A control circuit of minimal size for quickly charging a large-capacity battery of an electronic device is connected between a charging port and the battery. The charging control unit includes a charging control chip, a first resistor, and a current adjusting unit. The charging control chip provides a predefined voltage to charge the battery. The current adjusting unit includes a second resistor and a switching unit connected between the charging control chip and the battery, in parallel with the first resistor. The switching unit detects whether the electronic device is on or off. If the electronic device is on, the switching unit turns off to disconnect the second resistor from the battery. If the electronic device is off, the switching unit turns on to connect the second resistor to the battery. An electronic device including the charging control circuit is also provided.

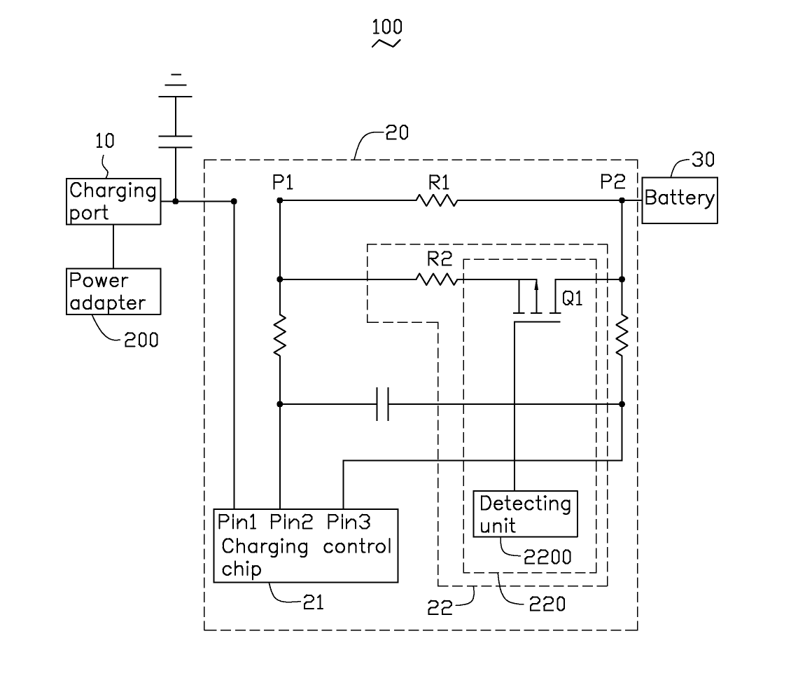

### FIELD

The present disclosure relates to electronic devices, and particularly to an electronic device with a charging control circuit.

### BACKGROUND

Current battery advancements have allowed the battery capacity of electronic devices, such as mobile phones, to become larger, which incidentally also increases the charging time. Increasing the charging speed can be achieved by using larger sized power adapters to increase the charging current.

### BRIEF DESCRIPTION OF THE DRAWING

Many aspects of the present disclosure should be better understood with reference to the following drawing. The components in the drawing are not necessarily drawn to scale, the emphasis instead being placed upon clearly illustrating the principles of the present device.

The FIGURE is a circuit diagram of an electronic device with charging control circuit in accordance with an exemplary embodiment.

### DETAILED DESCRIPTION

Embodiments of the present disclosure are described with reference to the accompanying drawing.

The FIGURE shows an exemplary embodiment of an electronic device 100. The electronic device 100 can include a charging port 10, a charging control circuit 20, and a battery 30. The charging control circuit 20 is electrically connected between the charging port 10 and the battery 30. The charging port 10 is electrically connected to a power adapter 200 and receives power from the power adapter 200.

The charging control circuit 20 can include a charging control chip 21, a first resistor R1, and a current adjusting unit 22. The charging control chip 21 receives power from the power adapter 200 via the charging port 10 and provides a certain voltage/current to the battery 30 to recharge the battery 30. The charging control chip 21 includes a first pin PIN1, a second pin PIN2, and a third pin PIN3. The first pin PIN1 is electrically connected to the charging port 10 to receive the power supplied by the power adapter 200. A first end P1 of the first resistor R1 is electrically connected the second pin PIN2 of the charging control chip 21, and a second end P2 of the first resistor R1 is electrically connected to the battery 30. The second pin PIN2 outputs a charging current to the battery 30 via the first resistor R1. The third pin PIN3 is electrically connected to the second end P2 of the first resistor R1. The charging control chip 21 detects any voltage drop across the first resistor R1 by detecting a voltage between the second pin PIN2 and the third pin PIN3, and adjusts the current being output by the second pin PIN2 according to a detected voltage drop across the first resistor R1, to ensure that the voltage drop across the first resistor R1 stays at a fixed value. In this embodiment, the voltage between the second pin PIN2 and the third pin PIN3 is in proportion to the voltage drop across the first resistor R1, thus the voltage between the second pin PIN2 and the third pin PIN3 has a fixed value.

The current adjusting unit 22 is connected between the second pin PIN2 of the charging control chip 21 and the battery 30, in parallel with the first resistor R1. The current adjusting unit 22 includes a second resistor R2 and a switching unit 220 connected in series between the first end P1 and the second end P2 of the first resistor R1.

The switching unit 220 detects whether the electronic device 100 is powered on or is off. If the switching unit 220 determines that the electronic device 100 is powered on, the switching unit 220 turns off to cut off the connection between the second resistor R2 and the battery 30. If the switching unit 220 determines that the electronic device 100 is off, the switching unit 220 turns on to connect the second resistor R2 to the battery 30. Before the second resistor R2 is connected to the battery 30, the resistance value between the second pin PIN2 and the third pin PIN3 is substantially equal to the resistance value of the first resistor R1. When the second resistor R2 is connected to the battery 30, the resistance value between the second pin PIN2 and the third pin PIN3 is substantially equal to a resistance value of the first resistor R1 and the second resistor R2 in parallel with each other. That is, when the second resistor R2 is connected to the battery 30, the resistance value between the second pin PIN2 and the third pin PIN3 is reduced. To ensure that the voltage between the second pin PIN2 and the third pin PIN3 stays at the fixed value, the charging control chip 21 increases the current output by the second pin PIN2, thus the charging current being output from the second pin PIN2 to the battery 30 is increased, and the charging time for charging the battery 30 is shortened.

In this embodiment, the switching unit 220 can include a metal-oxide-semiconductor field-effect transistor (MOSFET) Q1 and a detecting unit 2200. A source of the MOSFET Q1 is connected to the second resistor R2, a drain of the MOSFET Q1 is connected to the battery 30, and a gate of the MOSFET Q1 is connected to the detecting unit 2200. In this embodiment, the MOSFET Q1 is a P-channel MOSFET. The detecting unit 2200 detects whether the electronic device 100 is off or powered on. If the detecting unit 2200 determines that the electronic device 100 is powered on, the detecting unit 2200 outputs a high-level voltage to the MOSFET Q1, to turn off the MOSFET Q1. If the detecting unit 2200 determines that the electronic device 100 is off, the detecting unit 2200 outputs a low-level voltage to the MOSFET Q1, to turn on the MOSFET Q1.

In this embodiment, the detecting unit 2200 is a power supply system port of the electronic device 100 and a high-level voltage is output when the electronic device 100 is powered on, and the low-level voltage is output when the electronic device 100 is off. In detail, if the electronic device 100 is powered on in response to an operation of a user, the detecting unit 2200 outputs the high-level voltage to the MOSFET Q1, and if the electronic device 100 is turned off by the user, the detecting unit 2200 outputs the low-level voltage to the MOSFET Q1. In an alternative embodiment, the detecting unit 2200 is a processing chip, the processing chip outputs the high-level voltage when the processing chip determines that the electronic device is powered on, and outputs the low-level voltage when the processing determines that the electronic device has been turned off.

In other embodiments, the MOSFET Q1 may be an N-channel MOSFET or other electronic elements with a switch function.

The electronic device 100 and the charging control circuit 20 in the present disclosure may further include other electric elements not related to the present disclosure or the improvement thereof, and are not described herein.

Although the present disclosure has been specifically described on the basis of exemplary embodiments thereof, the disclosure is not to be construed as being limited thereto. Various changes or modifications may be made to the embodiments without departing from the scope and spirit of the disclosure.

What is claimed is:

1. An electronic device comprising:
a battery;
a charging port configured to electrically connect a power adapter, and the battery receiving power from the power adapter via the charging port; and
a charging control circuit connected between the battery and the charging port, the charging control circuit comprising:
a charging control chip comprising a first pin, a second pin, and a third pin, wherein, the first pin is configured to electrically connected the charging port, the charging control chip is configured to receive power from the power adapter via the charging port and the first pin, and provide a charging current to the battery to recharge the battery via the second pin;
a first resistor configured to electrically connected between the second pin of the charging chip and the battery, the third pin of the charging chip configured to connect to the battery and the first resistor, the charging control chip configured to detect any voltage drop across the first resistor by detecting a voltage between the second pin and the third pin, and adjust a current being output by the second pin according to a detected voltage drop across the first resistor, to ensure that the voltage drop across the first resistor stays at a fixed value; and
a current adjusting unit comprising a second resistor and a switching unit connected between the second pin of the charging chip and the battery in series; wherein the switching unit is configured to detect whether the electronic device is powered on or is off, if the switching unit determines that the electronic device is powered on, the switching unit turns off to cut off a connection between the second resistor and the battery; if the switching unit determines that the electronic device is off, the switching unit turns on to connect the second resistor to the battery.

2. The electronic device as recited in claim 1, wherein the voltage between the second pin and the third pin is in proportion to the voltage drop on the first resistor.

3. The electronic device as recited in claim 1, wherein the switching unit comprises a metal-oxide-semiconductor field-effect transistor (MOSFET) and a detecting unit, a source of the MOSFET is connected to the second resistor, a drain of the MOSFET is connected to the battery, and a gate of the MOSFET is connected to the detecting unit, the detecting unit detects whether the electronic device is off or powered on, if the detecting unit determines that the electronic device is powered on, the detecting unit outputs a high level voltage to the MOSFET to turn off the MOSFET, if the detecting unit determines that the electronic device is off, the detecting unit outputs a low level voltage to the MOSFET to turn on the MOSFET.

4. The electronic device as described in claim 3, wherein the MOSFET is a p-channel MOSFET, the detecting unit is a power supply system port of the electronic device and outputs the high-level voltage when the electronic device is powered on, and outputs the low-level voltage when the electronic device is off.

5. The electronic device as described in claim 3, wherein the detecting unit is a processing chip, the processing chip outputs a high level voltage when the processing chip determines that the electronic device is powered on, and outputs a low level voltage when the processing determines that the electronic devices is off

6. A charging control circuit applied in an electronic device, the electronic device comprising a battery, a charging port configured to electrically connect a power adapter to the battery, the charging control circuit comprising:
a charging control chip comprising a first pin, a second pin, and a third pin, wherein the first pin is configured to electrically connect the charging port, the charging control chip is configured to receive power from the power adapter via the charging port and the first pin, and provide a charging current to the battery to recharge the battery via the second pin;
a first resistor configured to electrically connect between the second pin of the charging chip and the battery, the third pin of the charging chip configured to connect to the battery and the first resistor, the charging control chip configured to detect any voltage drop across the first resistor by detecting a voltage between the second pin and the third pin, and adjust a current being output by the second pin according to a detected voltage drop across the first resistor, to ensure that the voltage drop across the first resistor stays at a fixed value; and
a current adjusting unit comprising a second resistor and a switching unit connected between the second pin of the charging chip and the battery in series; wherein the switching unit is configured to detect whether the electronic device is powered on or is off, if the switching unit determines that the electronic device is powered on, the switching unit turns off to cut off a connection between the second resistor and the battery; if the switching unit determines that the electronic device is off, the switching unit turns on to connect the second resistor to the battery.

7. The charging control circuit as described in claim 6, wherein the voltage between the second pin and the third pin is in proportion to the voltage drop on the first resistor.

8. The charging control circuits as described in claim 6, wherein the switching unit comprises a metal-oxide-semiconductor field-effect transistor (MOSFET) and a detecting unit, a source of the MOSFET is connected to the second resistor, a drain of the MOSFET is connected to the battery, and a gate of the MOSFET is connected to the detecting unit, the detecting unit detects whether the electronic device is off or powered on, if the detecting unit determines that the electronic device is powered on, the detecting unit outputs a high-level voltage to the MOSFET to turn off the MOSFET, if the detecting unit determines that the electronic device is off, the detecting unit outputs a low level-voltage to the MOSFET to turn on the MOSFET.

9. The charging control circuit as described in claim 8, wherein the MOSFET is a p-channel MOSFET, the detecting unit is a power supply system port of the electronic device and outputs the high-level voltage when the electronic device is powered on, and outputs the low-level voltage when the electronic device is off.

10. The charging control circuit as described in claim 8, wherein the detecting unit is a processing chip, the processing chip outputs a high level voltage when the processing chip determines that the electronic device is powered on, and outputs a low level voltage when the processing determines that the electronic devices is off.
